(19) United States
(12) Patent Application Publication
(10) Pub. No.: US 2009/0166099 A1
(43) Pub. Date: Jul. 2, 2009

(54) UNLOCKING METHOD WITH TOUCH SENSOR

(75) Inventors: Hsi-Kun Chen, Taoyuan County (TW); Hui-Wen Wang, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: HTC CORPORATION, Taoyuan County (TW)

(21) Appl. No.: 12/241,062

(22) Filed: Sep. 30, 2008

(30) Foreign Application Priority Data
Dec. 31, 2007 (TW) 96151562

(51) Int. Cl. G06F 3/044; G06F 3/041; G06F 3/042

(52) U.S. Cl. 178/18.06; 178/18.03; 178/18.09

(57) ABSTRACT

An unlocking method with a touch sensor is provided. The method is adapted to a portable device having a touch sensor, wherein the portable device is at a lock state. The method is as follows. First, a signal generated by an input device is received by the touch sensor. Next, a movement of the touch sensor triggered by the input device is sensed. Next, the signal is identified to determine whether or not the input device is an effective unlock device. Finally, when the input device is the effective unlock device and the movement is an effective movement, the lock state of the portable device is switched to an unlock state.

### CROSS-REFERENCE TO RELATED APPLICATION

This application claims the priority benefit of Taiwan application serial no. 96151562, filed on Dec. 31, 2007. The entirety of the above-mentioned patent application is hereby incorporated by reference herein and made a part of this specification.

### BACKGROUND OF THE INVENTION

1. Field of the Invention

The present invention relates to an operation method for a touch sensor. More particularly, the present invention relates to an unlocking method with a touch sensor.

2. Description of Related Art

In a present era of information explosion, electronic communications become indispensable in our daily life, and portable communication devices, especially portable mobile communication devices such as cell phone or wireless communication electronic devices etc. are generally used for communication. A conventional cell phone generally includes a casing, a host module and a man machine interface (MMI), wherein the host module is disposed within the casing, and the MMI is disposed on the casing and is electrically coupled to the host module. The MMI may be a keyboard, a microphone, a speaker or a flat panel display etc.

In order to stimulate a purchase desire of consumers for buying cell phones, functions and appearance of the cell phone are developed continuously by various cell phone manufactures. Taking a portable handheld device such as a personal digital assistant (PDA) as an example, besides features of powerful functions and slim-sized etc are taken into consideration, a desired function thereof may be hopefully activated and executed within a very short time, especially for those frequently used functions (such as editing messages, or inquiring phone call records). If the frequently used functions may be swiftly activated during operation of the portable device, utilization convenience of the portable device is then improved. To cope with the aforementioned requirements, hot keys corresponding to the specific frequently used functions are generally designed on the keyboard or the casing of the handheld device by manufactures.

However, when the portable device is put into a handbag or a pocket by the user, it is liable to be squeezed by other objects (such as keys) within the handbag or the pocket, even the hot keys on the portable device may be squeezed, such that a specific function (such as a dialling function) of the portable device may be accidentally executed. To prevent a unintended -press of the hot key on the portable device from activating a certain specific function, a commonly used method presently is to enable a lock and unlock function to the hot keys of the portable device, such that when the portable device is in an idle state, the device or an input interface thereof may be locked, and only when the hot keys are unlocked, may the hot keys and an input device thereof be normally used.

However, multi operations are required to be performed for achieving unlocking of the portable device, and the portable device may even be unlocked due to unintended input or unintended touch. Therefore, utilization convenience of the portable device is decreased.

### SUMMARY OF THE INVENTION

The present invention is directed to an unlocking method, by which unlocking due to unintended input or unintended touch is avoided.

The present invention is directed to an unlocking method, which may improve a utilization continence of a portable device.

The present invention provides an unlocking method for a portable device having a touch sensor, wherein the portable device is at a lock state. The method is as follows. First, a signal generated from an input device is received by the touch sensor. Next, a movement of the touch sensor triggered by the input device is sensed. Next, the signal is identified. Finally, the lock state of the portable device is switched to an unlock state if the input device is an effective unlock device, and when the movement is a relative movement of the touch sensor corresponding to a casing of the portable device.

According to an exemplary embodiment of the present invention, the step of determining the input device to be the effective unlock device includes identifying the input device according to a touch area, a touch capacitance or a temperature of the input device sensed by the touch sensor, when the input device touches the touch sensor.

According to an exemplary embodiment of the present invention, the step of identifying the input device further includes determining the input device is the effective unlock device when the input device is a conductor, wherein the conductor is a finger.

According to an exemplary embodiment of the present invention, the step of determining the input device to be the effective unlock device further includes determining the input device is the effective unlock device when a touch area of the input device sensed by the touch sensor matches a predetermined range.

According to an exemplary embodiment of the present invention, the step of sensing the movement of the touch sensor triggered by the input device further includes confirming a temporary staying time of the input device staying on the touch sensor matches a predetermined unlocking time limit.

According to an exemplary embodiment of the present invention, the step of sensing the movement of the touch sensor includes sensing the movement of the touch sensor triggered by the input device via a variation sensor disposed below the touch sensor, wherein the variation sensor includes an optical sensor, a pressure sensor and a thin-film sensor.

According to an exemplary embodiment of the present invention, the portable device includes a feature phone, a smartphone, a PDA, a PDA phone and a touch phone.

The present invention provides an unlocking method for a portable device having a touch sensor, wherein the portable device is at a lock state, and a compressible space is formed below the touch sensor. The method is as follows. First, a signal generated from an input device is received by the touch sensor. Next, a space variation of the compressible space is detected. Next, the signal is identified to determine whether or not the input device is an effective unlock device. Finally, the lock state of the portable device is switched to an unlock state if the input device is the effective unlock device and the compressible space is decreased.

According to an exemplary embodiment of the present invention, the step of identifying the input device includes identifying the input device according to a touch area, a touch capacitance or a temperature of the input device sensed by the touch sensor, when the input device touches the touch sensor.

According to an exemplary embodiment of the present invention, the step of identifying the input signal for determining whether or not the input device is the effective unlock device further includes determining the input device to be the effective unlock device if the input device is a conductor, wherein the conductor includes a finger.

According to an exemplary embodiment of the present invention, the step of identifying the input signal for determining whether or not the input device is the effective unlock device further includes determining the input device to be the effective unlock device when a touch area of the input device sensed by the touch sensor matches a predetermined range.

According to an exemplary embodiment of the present invention, the step of detecting the space variation of the compressible space further includes confirming a temporary staying time of the input device staying on the touch sensor matches a predetermined unlocking time limit.

According to an exemplary embodiment of the present invention, the step of detecting the space variation of the compressible space includes sensing the space variation of the compressible space below the touch sensor triggered by the input device via a variation sensor disposed below the touch sensor, wherein the variation sensor includes an optical sensor, a pressure sensor and a thin-film sensor.

According to an exemplary embodiment of the present invention, the portable device includes a feature phone, a smartphone, a PDA, a PDA phone and a touch phone.

In the present invention, based on two judgement principles including confirming whether or not the movement of the touch sensor triggered by the input device is the effective movement and confirming whether or not the input device is the effective unlock device, whether or not an input action performed on the locked touch sensor by the input device is an unlock action is then determined. Therefore, a situation that the lock state of the locked touch sensor is switched to an unlock state due to meaningless touch or press may be avoided. Moreover, by applying the unlocking method of the present invention, only a simple input action is required to be performed via the input device for successfully unlocking the touch sensor according to multi judgement steps, and the conventional unlocking method for the portable device via a serial of unlocking actions is unnecessary, such that utilization convenience of the portable device is improved.

In order to make the aforementioned and other objects, features and advantages of the present invention comprehensible, a preferred embodiment accompanied with figures is described in detail below.

### BRIEF DESCRIPTION OF THE DRAWINGS

FIG. 1 is a flowchart illustrating an unlocking method according to an exemplary embodiment of the present invention.

FIG. 2 is a schematic diagram illustrating a thin-film sensor before being pressed.

FIG. 3 is a schematic diagram illustrating a thin-film sensor after being turned on.

### DESCRIPTION OF EMBODIMENTS

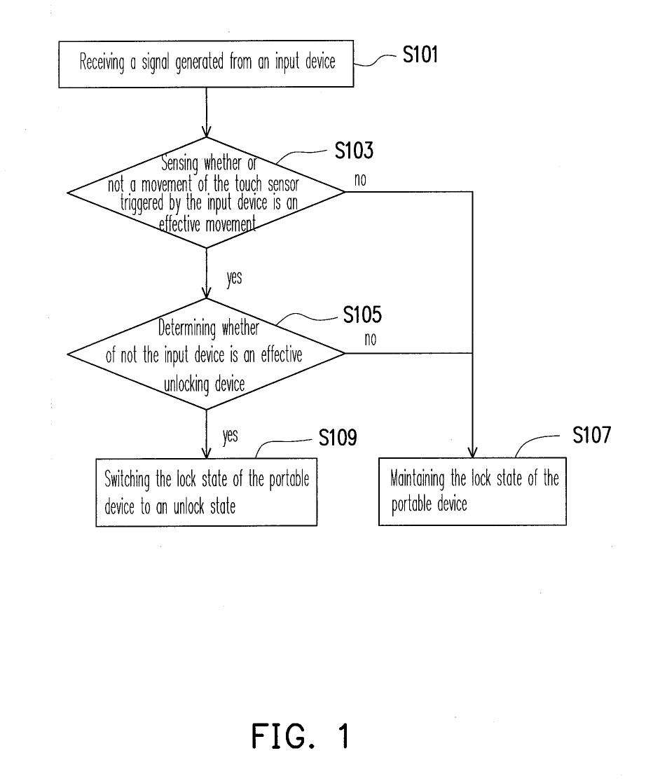

FIG. 1 is a flowchart illustrating an unlocking method according to an exemplary embodiment of the present invention. Referring to FIG. 1, in step S101, an input action is performed to a touch sensor located on a portable device via an input device, and the portable device receives a signal generated by the input action via the touch sensor, wherein the portable device is in a lock state. Moreover, the touch sensor may be a touch keyboard, a button, a touch pad, a capacitive sensor or a touch screen, or may be a mixed sensor having a resistive and the capacitive features. In addition, the portable device includes a feature phone, a smartphone, a PDA, a PDA phone and a touch phone.

Next, in step S103, whether or not the touch sensor is effectively moved under function of the input device is judged. Namely, an effective movement of the touch sensor triggered by the input device when the input action is performed to the touch sensor by the input device is sensed.

In an embodiment, the movement of the sensor may be a relative movement of the touch sensor corresponding to a casing of the portable device, wherein a step of sensing the movement of the touch sensor includes sensing the relative movement of the touch sensor corresponding to the casing of the portable device triggered by the input device via a variation sensor disposed below the touch sensor, wherein the variation sensor includes an optical sensor, a pressure sensor and a thin-film sensor.

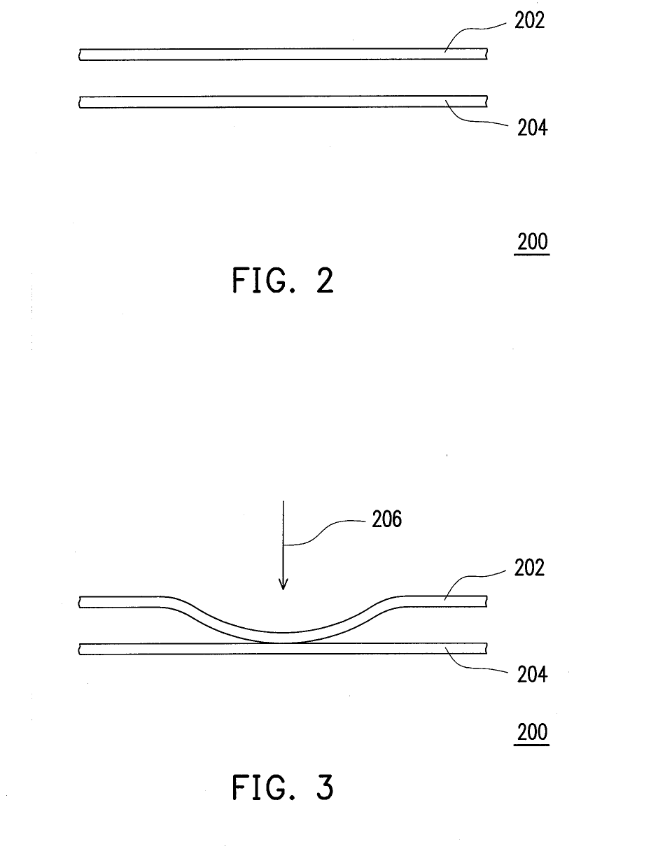

As to the optical sensor, if the relative movement causes a change of an optical state, for example, an infrared light may be blocked and becomes discontinuous due to the relative movement, the relative movement then may be judge to be the effective movement. As to the pressure sensor, if the relative movement causes a change of a pressure state, the relative shifting then may be judge to be the effective movement. FIG. 2 is a schematic diagram illustrating a thin-film sensor before being pressed. FIG. 3 is a schematic diagram illustrating a thin-film sensor after being turned on. Referring to FIG. 2 and FIG. 3, the thin-film sensor 200 includes a first thin film layer 202 and a second thin film layer 204 (referring to FIG. 2), when an external force (for example, a force direction 206 shown as FIG. 3) is exerted to one of the first thin film layer 202 and the second thin film layer 204, or exerted to both layers of the thin films 202 and 204, the first thin film layer 202 and/or the second thin film layer 204 are relatively moved, such that the two layers may be touched with each other and are electrically connected (shown as FIG. 3), and therefore the relative movement is then judged to be the effective relative movement. Moreover, in another embodiment, while the movement of the touch sensor triggered by the input device is sensed, whether or not a temporary staying time of the input device staying on the touch sensor matches a predetermined unlocking time limit is further judged. Namely, when a relative movement of the touch sensor relative to the casing of the portable device is triggered by the input device, and when the time of the input device continually staying on the touch sensor matches the predetermined unlocking time limit, for example, when the input device continually stays on the touch sensor for m second, wherein m is a positive integer, the relative movement between the touch sensor and the casing of the portable device triggered by the input device is then judged to be the effective movement.

In another embodiment, a compressible space is formed below the touch sensor, and the method of sensing the movement of the touch sensor is as follows. First, when an input action is performed to the touch sensor by the input device, a space variation (for example, decreasing of the compressible space) of the compressible space caused by the input action of the input device is detected. Next, the relative movement of the touch sensor is judged to be an effective movement according to the space variation, i.e. decreasing of the compressible space. Wherein, the relative movement of the touch sensor not only represents the relative movement between the touch sensor and the portable device, but also represents all the relative movement of the touch sensor caused by decreasing of the compressible space below the touch sensor when the input action is performed to the touch sensor by the input device. Moreover, in the present embodiment, the step of detecting the space variation of the compressible space further includes sensing the decreasing of the compressible space blow the touch sensor triggered by the input device via a variation sensor disposed below the touch sensor, wherein the variation sensor may be an optical sensor, a pressure sensor and an electric sensor. In addition, when it is the pressure sensor that is allocated below the touch sensor, the relative movement of the touch sensor then may be judged by sensing a pressure variation caused by decreasing of the compressible space. Moreover, in another embodiment, the step of detecting the space variation of the compressible space further includes confirming a temporary staying time of the input device staying on the touch sensor being greater than a predetermined unlocking time limit. Namely, when the compressible space below the touch sensor is varied, i.e. decreased under flnction of the input device, and when the time of the input device continually staying on the touch sensor is greater than the predetermined unlocking time limit, the relative movement of the touch sensor triggered by the input device is then judged to be the effective movement.

In the present embodiment, when a result of sensing whether or not the movement of the touch sensor triggered by the input device is the effective movement reveals that the there is no effective movement of the touch sensor under function of the input device, the portable device then maintains the lock state (step S107). Conversely, when the result of sensing whether or not the movement of the touch sensor triggered by the input device is the effective movement reveals that the movement of the touch sensor triggered by the input device is the effective movement, step S105 is then executed.

In the step S105, whether or not the input device is an effective unlock device is determined. Wherein, a signal generated by the input device is identified, so as to determine whether or not the input device is the effective unlock device. For example, whether or not the input device is the effective unlock device is determined according to a touch area, a touch capacitance or a temperature of the input device sensed by the touch sensor, when the input device touches the touch sensor.

Moreover, in an embodiment, judging whether or not the input device is the effective unlock device includes that the input device is judged to be the effective unlock device if the input device is a conductor, wherein the conductor may be a finger. Moreover, in another embodiment, judging whether or not the input device is the effective unlock device further includes that the input device is judged to be the effective unlock device if a touch area of the input device sensed by the touch sensor matches a predetermined range, wherein the predetermined range may be a touch area of a single finger, namely, if the input device is the finger, and the touch sensor is touched by the single finger, the input device is then judged to be the effective unlock device.

When the movement of the touch sensor triggered by the input action of the input device is judged to be the effective movement, and meanwhile the input device is judged to be not the effective unlock device, the portable device is then maintained to the lock state (step S107). On the other hand, when the movement of the touch sensor triggered by the input action of the input device is judged to be the effective movement, and meanwhile the input device is judged to be the effective unlock device, the portable device is then switched from the lock state to the unlock state (step S109).

In the aforementioned embodiment, in the step of judging whether or not the input action performed to the touch sensor by the input device may switch the portable device from the lock state to the unlock state, whether or not the movement of the touch sensor triggered by the input action of the input device is the effective movement is first judged, and then whether or not the input device is the effective unlock device is judged. In the present invention, step sequence of judging the effective movement and the effective unlock device is not limited (i.e. whether or not the step S103 is first executed or the step S105 is first executed is not limited by the present invention). Namely, in an actual application, the step S105 may be first executed to judge whether or not the input device is the effective unlock device, and then the step S103 is executed to judge whether or not the relative movement of the touch sensor triggered by the input action performed to the touch sensor by the input device is the effective movement. Moreover, the step S103 of judging the effective movement and the step S105 of judging the effective unlock device may be simultaneously executed.

In the present invention, there are two judgement principles, one is to confirm whether or not the movement of the touch sensor triggered by the input device is the effective movement, for example, if the touch sensor is a button, whether or not the button is pressed and moved is then judged; another one is to confirm whether or not the input device is the effective unlock device, for example, whether or not the input action performed to the locked portable device by the input device is the unlock action is determined by whether or not the input device is the finger. Based on such multi judgement principles, a situation that the lock state of the locked touch sensor is switched to the unlock state due to meaningless touch or press may be avoided, and accordingly execution of functions corresponding to the hot keys such as automatic dialling which may cause power consumption of the portable device and unexpected consumption of communication charge due to unintended touch of the hot key may be avoided. Moreover, by applying the unlocking method of the present invention, only a simple input action is required to be performed via the input device for successfully unlocking the touch sensor according to multi judgement steps, and the conventional unlocking method for the portable device via a serial of unlocking actions is unnecessary, such that utilization convenience of the portable device is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An unlocking method, for a portable device having a touch sensor, wherein the portable device is in a lock state, the unlocking method comprising:
receiving a signal generated from an input device by the touch sensor;
sensing a movement of the touch sensor triggered by the input device;
identifying the signal for determining whether or not the input device is an effective unlock device; and
switching the lock state of the portable device to an unlock state when the input device is the effective unlock device, and when the movement is a relative movement of the touch sensor corresponding to a casing of the portable device.

2. The unlocking method as claimed in claim 1, wherein the step of determining the input device comprises determining the input device according to a touch area, a touch capacitance or a temperature of the input device sensed by the touch sensor, when the input device touches the touch sensor.

3. The unlocking method as claimed in claim 1, wherein the step of determining the input device further comprises determining the input device to be the effective unlock device if the input device is a conductor.

4. The unlocking method as claimed in claim 3, wherein the conductor comprises a finger.

5. The unlocking method as claimed in claim 1, wherein the step of determining the input device further comprises determining the input device to be the effective unlock device when a touch area of the input device sensed by the touch sensor matches a predetermined range.

6. The unlocking method as claimed in claim 1, wherein the step of sensing the movement of the touch sensor triggered by the input device further comprises confirming a temporary staying time of the input device staying on the touch sensor matches a predetermined unlocking time limit.

7. The unlocking method as claimed in claim 1, wherein the step of sensing the movement of the touch sensor comprises sensing the movement of the touch sensor triggered by the input device via a variation sensor disposed below the touch sensor.

8. The unlocking method as claimed in claim 7, wherein the variation sensor comprises an optical sensor, a pressure sensor or a thin-film sensor.

9. The unlocking method as claimed in claim 1, wherein the portable device comprises a smartphone, a personal digital assistant (PDA), a PDA phone and a touch phone.

10. An unlocking method, for a portable device having a touch sensor, wherein the portable device is in a lock state, and a compressible space is formed below the touch sensor, the unlocking method comprising:
receiving a signal generated from an input device by the touch sensor;
detecting a space variation of the compressible space;
identifying the signal for determining whether or not the input device is an effective unlock device; and
switching the lock state of the portable device to an unlock state when the input device is the effective unlock device, and when the compressible space is decreased.

11. The unlocking method as claimed in claim 10, wherein the step of determining the input device comprises determining the input device according to a touch area, a touch capacitance or a temperature of the input device sensed by the touch sensor, when the input device touches the touch sensor.

12. The unlocking method as claimed in claim 10, wherein the step of determining the input device further comprises determining the input device to be the effective unlock device if the input device is a conductor.

13. The unlocking method as claimed in claim 12, wherein the conductor comprises a finger.

14. The unlocking method as claimed in claim 10, wherein the step of determining the input device further comprises determining the input device to be the effective unlock device when a touch area of the input device sensed by the touch sensor matches a predetermined range.

15. The unlocking method as claimed in claim 10, wherein the step of detecting the space variation of the compressible space further comprises confirming a temporary staying time of the input device staying on the touch sensor matches a predetermined unlocking time limit.

16. The unlocking method as claimed in claim 10, wherein the step of detecting the space variation of the compressible space comprises sensing the space variation of the compressible space below the touch sensor that triggered by the input device via a variation sensor disposed below the touch sensor.

17. The unlocking method as claimed in claim 16, wherein the variation sensor comprises an optical sensor, a pressure sensor or a thin-film sensor.

18. The unlocking method as claimed in claim 10, wherein the portable device comprises a smartphone, a personal digital assistant (PDA), a PDA phone and a touch phone.
